(19) United States
(12) Patent Application Publication
(10) Pub. No.: US 2025/0279609 A1
(43) Pub. Date: Sep. 4, 2025

(54) EXTENSION CORD PLUG ENCLOSURE

(71) Applicant: PROTECT-A-PLUG d/b/a, Vero Beach, FL (US)

(72) Inventor: Cynthia L. Wold, Vero Beach, FL (US)

(21) Appl. No.: 19/061,463

(22) Filed: Feb. 24, 2025

Related U.S. Application Data
(60) Provisional application No. 63/560,280, filed on Mar. 1, 2024.

(51) Int. Cl. H01R 13/506; H01R 13/52; H01R 13/533

(52) U.S. Cl. CPC H01R 13/506; H01R 13/5213; H01R 13/5219; H01R 13/533

(57) ABSTRACT

An enclosure for an extension cord connector having a first container member forming a first receptacle and a second container member forming a second receptacle. The adjoining edges of the first and second receptacle form a continuous edge with reciprocal tongue and groove coupling, the first container member forming a mirror image of the second container member. In operation, a connector of a power cord and extension cord are placed in the first receptacle formed by said first container member and the extension cord placed in the second receptacle secured together by coupling the tongue shape continuous edge of the second container member to the groove shape continuous edge of the first container member.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 63/560, 280 entitled “EXTENSION CORD PLUG ENCLOSURE”, filed Mar. 1, 2024. The contents of the above referenced application are incorporated herein by reference.

### FIELD OF THE INVENTION

This invention is directed to the field of portable power cords and, in particular, to an enclosure device for the plugs at the juncture of primary and extension power cords.

### BACKGROUND OF INVENTION

In recent years, the popularity of recreational vehicles (RVs) has surged. Post pandemic, more people are embracing the freedom and flexibility of travel. By recognizing the advantages of traveling with their own living/sleeping facilities, such modes of transportation provide a comfortable and convenient way to explore the country while enjoying modern amenities.

With the increase in RV usage, the challenges associated with using electrical cords have become pronounced. Electrical cords are an essential component that is required to transfer power from a fixed power outlet to the RV, thus enabling the use of the various onboard systems, appliances, and devices when the RV is parked. Electrical power is a necessity for air-conditioning, heating, refrigeration, television, internet, lights and so forth wherein the loss of electricity can quickly disrupt the convenience otherwise made possible by the RV. The probability of a loss of electricity is much higher when staying in an RV than a conventional home due to the use of power cords, the weakest link in the electrical circuit.

Power cords are exposed to a variety of environmental conditions that can lead to early degradation or failure. The problem is pronounced when these cords, also referred to as an RV electrical cord or shore power cord, must be extended to reach an electrical outlet a distance from the RV or boat. In such a situation, the power cord is coupled to an extension cord to reach the power outlet. The juncture where the plug of the primary power cord connects to the plug of the extension cord can become a problematic connection. RVs are often exposed to harsh environmental conditions such as rain, saltwater spray, extreme temperatures, and UV radiation. Since RVs are mobile, the connectors between power cords and extension cords are more likely to degrade due to the environmental exposure of the connectors resulting in failures or shorts. RVs have limited electrical capacities and loading the electrical system by using appliances that draw high amperage can cause overheating of the connectors, this situation is exasperated when the connectors are contaminated.

Water intrusion into the power cord's connectors or insulation can also lead to corrosion of the conductors and connections, ultimately resulting in failure. The power cord for an RV is typically rated for either 30 or 50 amps, depending on the amount of amperage required by the RV. The power cord is constructed of several layers of materials designed to provide durability, flexibility, and electrical insulation. The conductors are the wires inside the power cord that carry electrical current from the external power source to the RV or boat's electrical system. Power cords usually have multiple conductors, including hot, neutral, and ground wires. These conductors are typically made of stranded copper wire providing excellent conductivity and flexibility. Each conductor in the power cord is insulated to prevent electrical contact between conductors and to protect against electrical shock. The insulation material is typically made of thermoplastic compounds such as PVC (polyvinyl chloride) or TPE (thermoplastic elastomer). The outer jacket of the RV power cord provides additional protection for the internal conductors and insulation layers. The outer layer of the jacket is typically constructed of a weather-resistant material such as PVC, TPE, or rubber. This outer layer helps shield the internal components from physical damage, UV radiation, moisture, and harsh environmental conditions encountered during outdoor use. The connectors at the ends of the power cord facilitate the connection to external power sources and the RV's electrical inlet. These connectors are typically made of a moldable plastic or rubber, and they may include features like locking mechanisms or weatherproof seals to ensure a secure and weather-resistant connection. Protection from water is crucial; water can enter the insulated cord leading to corrosion that can reduce the amount of amperage or outright failure by blocking current flow. The plug and socket connector between the power cord and the extension cord are connectors that feature a locking mechanism, handle, and in some instances an indicator light to illustrate that the cord is carrying electricity. Traditional electrical cord management systems have limitations to effectively safeguard power cord connectors from the elements. Unprotected connectors lead to potential electrical hazards, system malfunctions, and safety concerns.

Corroded or improperly maintained connections between the power cord and the extension cord result in electrical resistance which can be detected by the heat generation. Before connecting the power cord and extension cord, it is recommended that the connectors are inspected for any signs of corrosion, dirt, or debris and dielectric grease applied for moisture protection and corrosion resistance. In reality, inspection of the connectors is typically overlooked in the rush to set up the RV wherein the lack of maintenance can result in dirty electrical contacts increasing resistance with the result being a reduction of amperage available to RV onboard systems.

While the description provided is focused on RVs, it is understood a similar problem occurs with any extension cord that is exposed to the elements. For instance, boats also require 30 or 50 amp cords and, should the boat be used in salt water, the resulting corrosion due to salt spray could quickly exacerbate the problem. For simplicity purposes, this specification including drawings will focus on RV's, but it is understood that the enclosure device of the instant invention can be used with boats as well as RVs defined as motorized or towable vehicles designed for temporary living accommodations and recreational activities including motorhomes; conventional travel trailers: fifth-wheel trailers, pop-up campers, truck campers, toy haulers; equipment haulers, and so forth.

### SUMMARY OF THE INVENTION

Recognizing the need for improved protection of RV electrical cord connectors, the instant invention is a weatherproof enclosure device designed specifically for RVs, boats, or other uses of electrical extension cords. The extension cord connector enclosure has a first container member forming a first receptacle and a second container member forming a second receptacle. The adjoining edges of the first and second receptacle form a continuous edge with reciprocal tongue and groove coupling. The first container member forms a mirror image of the second container member. Each member forms one half of an inlet and outlet. In operation, a connector of a power cord and extension cord are placed in the first receptacle formed by said first container member with the power cord positioned in the inlet and the extension cord placed in the outlet whereby the second receptacle is secured to the first receptacle by coupling the tongue shape continuous edge of the second container member to the groove shape continuous edge of the first container member, and the groove shape continuous edge of the second container member couples to the tongue shape continuous edge of the first container member.

An objective of the invention is to provide a protective enclosure for connectors having a preferred embodiment for use with 30 and 50 amp extension cords ensuring reliable performance and enhanced safety in diverse environmental conditions. The enclosure can accommodate various sized extension cords.

Another objective of the invention is to provide a durable translucent enclosure allowing visual detection of a power light used to indicate the extension cord is receiving electrical power.

Still another objective of the invention is to provide an enclosure that is constructed from high-quality, weather-resistant, UV-stabilized plastics with an entrance and exit opening that diverts exposure to rain, snow, and moisture to prevent water ingress and moisture buildup, thereby safeguarding electrical connectors from corrosion and damage.

Yet another objective of the invention is to provide a two-piece enclosure constructed from a single mold where the one member couples to a second container member to form an enclosure.

Still another objective of the invention is to provide a stackable enclosure for storage purposes and to minimize required storage space.

Yet another objective of the invention is to provide an enclosure that provides ventilation features for heat dissipation ensuring optimal performance and longevity of the connectors.

Still another objective of the invention is to provide an enclosure that includes bright and/or reflective signage to increase visibility and minimize tripping hazards.

Yet another objective of the invention is to provide an enclosure that complies with relevant safety standards and regulations governing electrical equipment and outdoor installations.

An advantage of the invention is that it addresses a a problem with the current extension cord usage, providing significant advancement in RV electrical cord protection by offering superior durability, reliability, and safety in challenging outdoor environments by addressing the inherent vulnerabilities of traditional cord management systems. The invention aims to enhance the overall RV experience and promote greater confidence and security for RV enthusiasts.

Still a further advantage of the invention is to provide a container that can be used for storage of items when not used for protection of power cords connectors.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a perspective view of a first container member spaced apart from a second container member;

FIG. 2 is a perspective view of the inner side of the first container member;

FIG. 3 is a perspective view of the outer side of a first container member, a second container forming a mirror image thereof, not shown;

FIG. 4A is a side view thereof;

FIG. 4B is a cross sectional of FIG. 4A along line AA;

FIG. 4C is an enlarged view of a tab depicted in FIG. 4B;

FIG. 5A is a top view thereof;

FIG. 5B is a cross sectional of FIG. 5A along line BB:

FIG. 6 is a first end view thereof;

FIG. 7 is a pictorial view depicting a power cord within the translucent first and second container member.

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

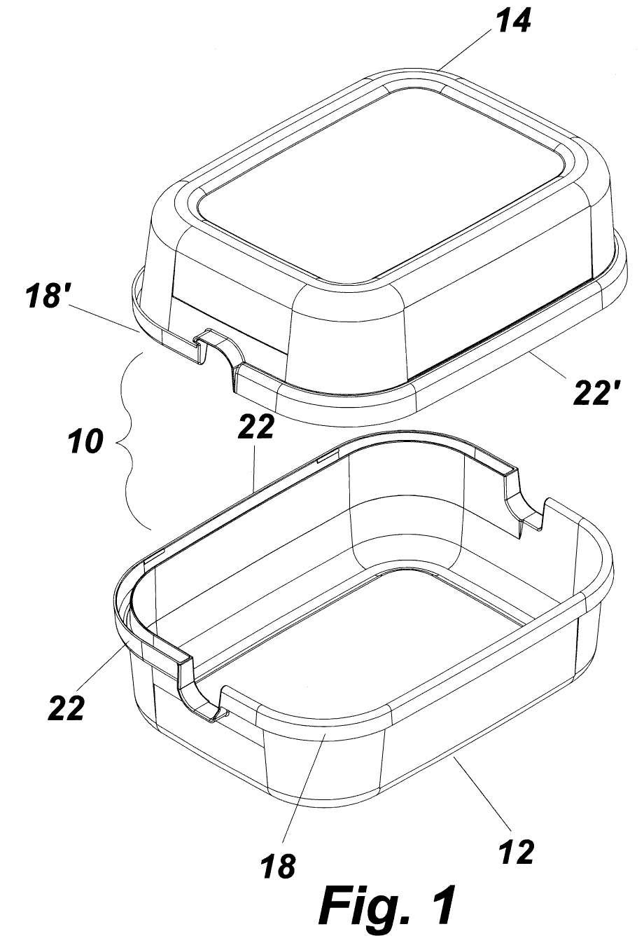

Now referring to FIG. 1, depicted is an enclosure 10 for an extension cord connector comprising a first container member 12 shown in an exploded view from a second container member 14. The second container member 14 is secured to the first container member 12 by coupling a tongue shaped continuous edge 18′ to the groove shaped continuous edge 22 of the first container member 12, and coupling the groove shaped continuous edge 22′ of the second container member 14 to the tongue shape continuous edge 18 of the first container member 12. The first container member 12 forms a mirror image of the second container member 14 allowing the container members 12, 14 to be interchangeable.

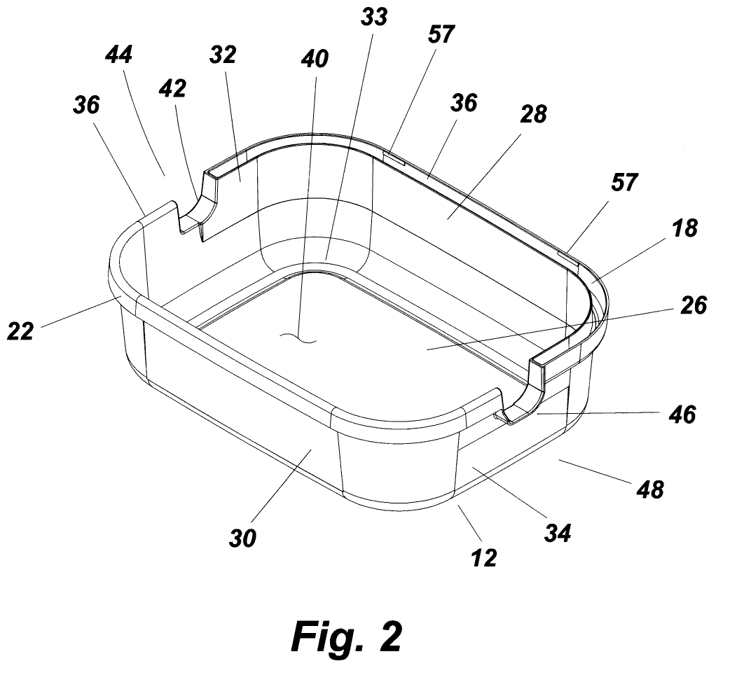

FIG. 2 is a perspective view of the inner side of the first container member 12. The first container member 12 defined by a base wall 26 with a first 28 vertical side wall spaced apart from a second 30 vertical side wall, and first vertical end wall 32 spaced apart from a second vertical end wall 34, said walls panels extending upwardly from the periphery 33 of the base wall 26 to a continuous edge 36 forming a first receptacle 40. The continuous edge 36 having a first scallop 42 centrally disposed along the first vertical end wall 32 forming a portion of an inlet 44 and a second scallop 46 centrally disposed along the second vertical end wall 34 forming a portion of an outlet 48. The continuous edge extending from the inlet 44 to the outlet 48 along a first sidewall 28 forming a groove shape 18. The continuous 36 edge extending from the outlet 48 to the inlet along the second vertical panel 30 forming a tongue shape 22.

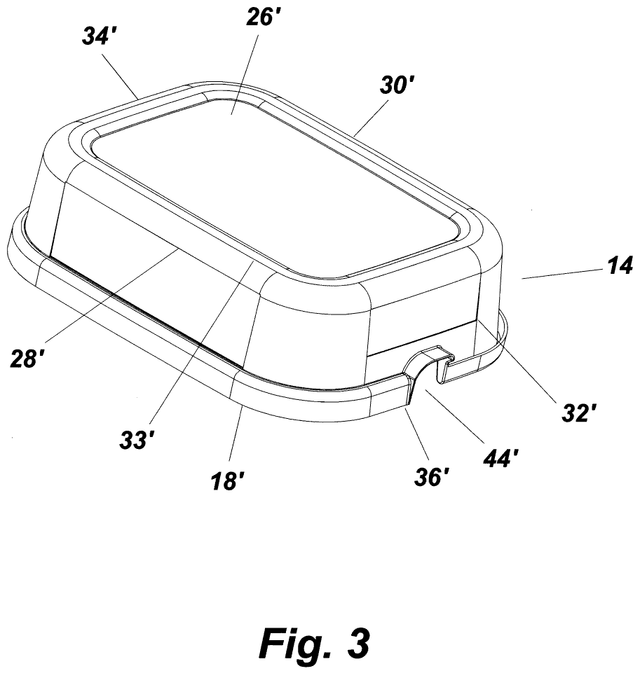

FIG. 3 depicts the second container member 14, a mirror image of the first container member 12, wherein each container member 12, 14 are formed from the same mold. The second container 14 is inverted wherein the groove shape of one member engages the tongue shape continuous edge of the opposite member; and the tongue shape of the other member engages the groove shape of the first member. FIG. 3 is a perspective view of the outer side of the second container member 14, a mirror image of the first container member 12, defined by a base wall 26′ with a first vertical side wall 28′ and second vertical side wall 30′ and first 32′ vertical end wall spaced apart from second vertical end wall 34′ extending from the periphery 33′ of the base wall 26′ to a continuous edge 36′ to form a receptacle. The continuous edge 36′ extending from the inlet 44′ forming a tongue shaped 18′ along one side and a groove shaped edge 22′ along the opposite side.

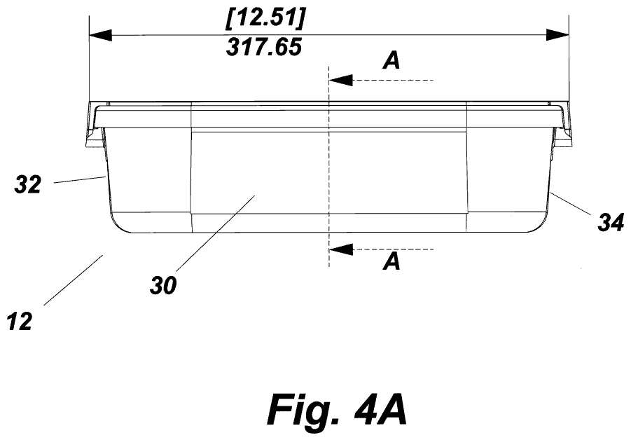

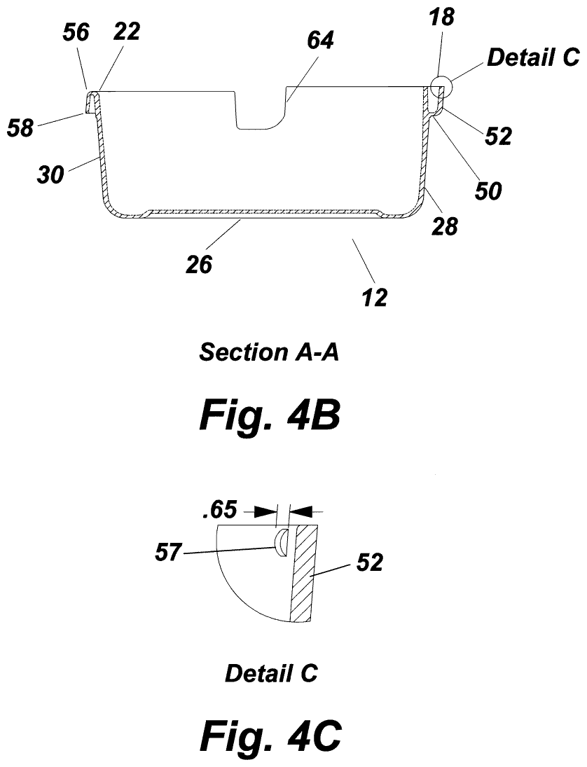

Referring to FIG. 4A, depicted is a side view of the first container member 12 depicting the side wall 30 and end walls 32 and 34. FIG. 4B is a cross sectional of FIG. 4A taken along line AA illustrating the groove 18 having a base 50 and outer wall 52 forming a receptacle about 9.13 mm. The groove 18 is constructed and arranged to receive a receptacle tongue. The groove 18 preferably includes a tab of about. 65 mm to provide a snap fit. The tongue has a lip 56 and depending wall 58 forming an insert about 8.45 mm. It is noted that the side walls 28, 34 are sloped to allow one member to be stacked into a second member. The stacking minimizes storage space and leaves one receptacle open wherein additional material may be stored. The length of the first container member is about 317 mm, sized to accommodate a conventional RV extension plug connector. The length may be increased or decreased and considered within the scope of this invention. For instance, a 50-amp extension cord commonly used for marine applications employs a straight-line connector wherein the dimensions of the container may be reduced accordingly.

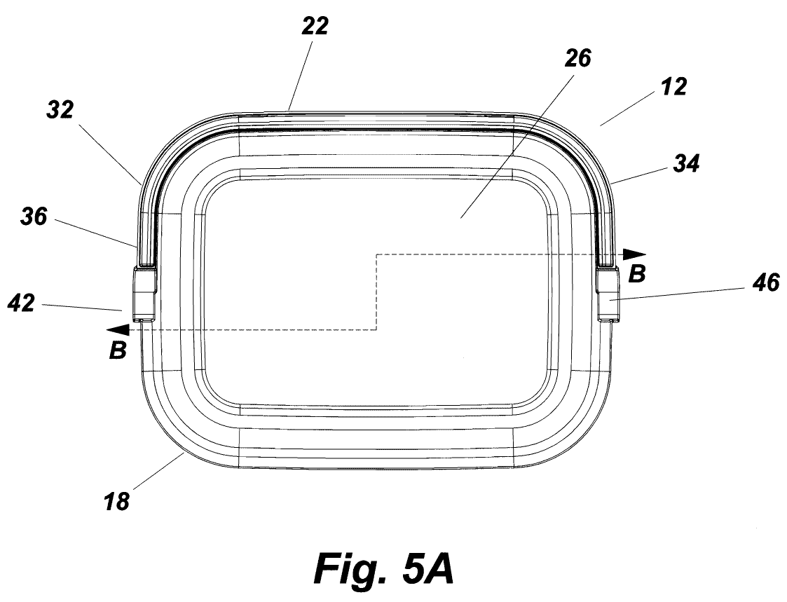

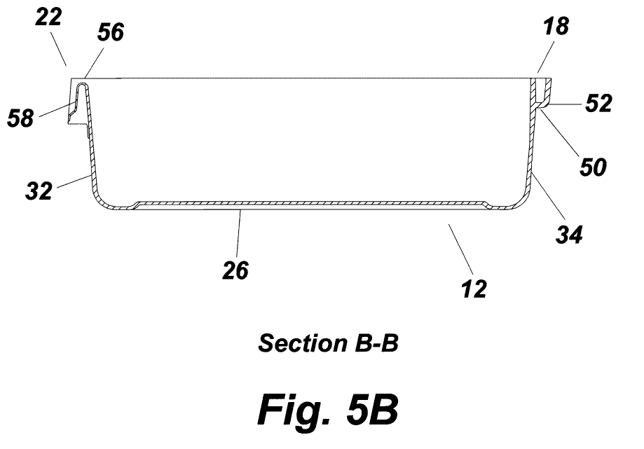

FIG. 5A is a top view of the first container member 12 depicting the base 26 bounded by the continuous edge 36. The continuous edge 36 bounded by the groove 22 extending on one side between the first scallop 42 and the second scallop 46, and by the tongue 18 extending on the opposite side between the first scallop 42 and the second scallop 46. FIG. 5B is a cross sectional of FIG. 5A along line BB illustrating the groove having a base 52 and outer wall 42. The tongue has a lip 56 and wall 58. The groove 18 and tongue change the configuration of the continuous wall at the scallops 42 and 46 which form an opening for receipt of the power cord. It is noted that the end walls 32, 34 are constructed and arranged to allow one member to be stacked into a second member.

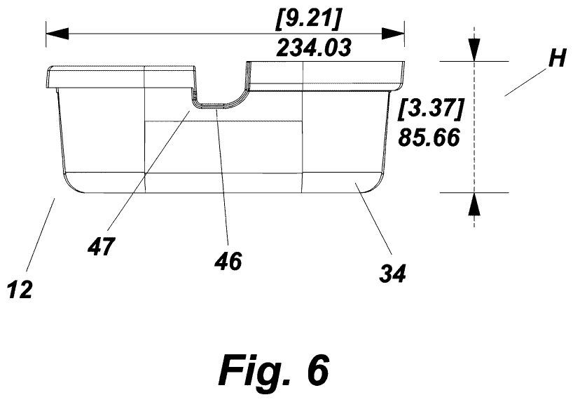

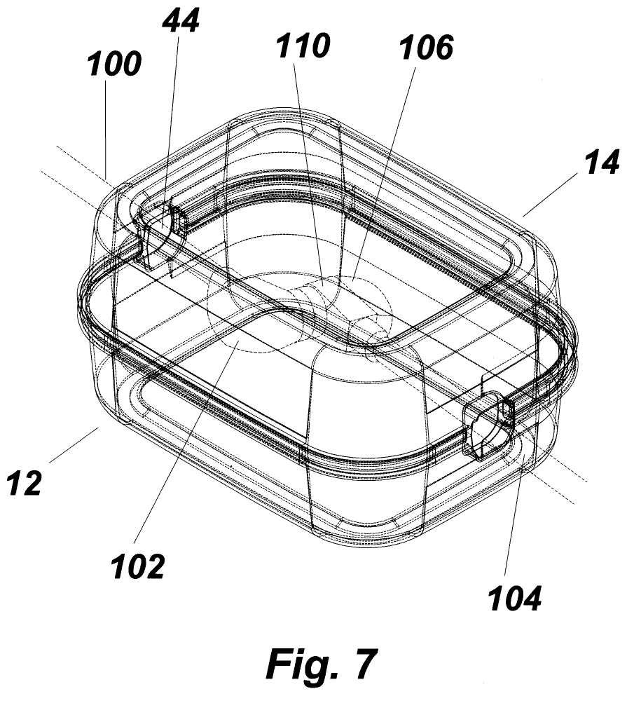

FIG. 6 is end 32 view depicting the scallop 42 with a vertical stop 43 for the groove 18. FIG. 7 is opposite end 34 view depicting the scallop 46 with a vertical stop 47 for the tongue 18. The tongue 18 and groove 22 are constructed and arranged to inhibit rain water from entering the enclosure. The scallops 42, 46 are angled outwardly to redirect rain water from entering the enclosure. The inlet and outlet are constructed and arranged to provide ventilation to allow air circulation to expel heat generated from the connector typically caused due to electrical high current flow, poor contact, or simply aging power cords. The width of the enclosure is about 235 mm “W” and about 85 mm high “H”, sized to receive a conventional 50 amp recreational vehicle power cord adapter.

FIG. 7 depicts the first container member 12 coupled to the second container member 14. A first power cord 100 having a connector 102 is coupled to a second power cord 104 connector 106. The first power cord 100 extends through the inlet 44 formed by the opposing scallops on a first end and the second power cord 104 extends through the outlet 48 formed by the opposing scallops on the second end. The first container member and the second container member are preferably formed from translucent or transparent weather-resistant UV inhibited suitable for outdoor use. In a preferred plastic material material embodiment, the plastic is polyethylene. The translucent or transparent material allows an indicator light 110 to be viewed either through the first container member or the second container member providing a visual indication that the cord is receiving electrical power. Alternatively, the container member may be made of opaque material wherein the connector and any indicator light are concealed.

The groove may include reinforcement ribs 57 to enhance securement to tongue, which will inhibit the second container member from moving during high winds, and deter small children from opening the enclosure. The ribs further enhance the tongue and groove coupling provides a sealing mechanism along the continuous edge a water-resistant seal. In an alternative embodiment, the continuous edge of each container member may include interlocking features to ensure a secure coupling between adjoining container members. For instance, the groove maybe constructed and arranged to include snap-fit mechanisms to facilitate easy assembly and disassembly of the enclosure.

The enclosure is configured to accommodate various sizes and types of extension cord connectors, including angled or bulky connectors. The illustrated length, width and depth are for example only. The first container member is interchangeable with said second container member.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way but may also be configured in ways that are not listed.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An enclosure for an extension cord connector comprising: a first container member defined as a base wall with first and second vertical side panels and first and second vertical end panels extending upwardly from the periphery of the base wall to a continuous edge forming a first receptacle; said continuous edge having a first scallop centrally disposed along said first vertical end wall forming a portion of an inlet and a second scallop centrally disposed along said second vertical end wall of said continuous edge forming a portion of an outlet, said continuous edge extending from said inlet to said outlet along a first sidewall forming an groove shape, said continuous edge extending from said outlet to said inlet along said second vertical panel forming tongue shape; a second container member forming a second receptacle, said second container member forming a mirror image of said first container member; wherein a connector of a power cord and extension cord is placed in said first receptacle formed by said first container member with said power cord positioned in said inlet and said extension cord placed in said outlet whereby said second container member is secured to said first container member by coupling a tongue shape continuous edge of said second container member to the groove shape continuous edge of said first container member, and said groove shape continuous edge of said second container member to the tongue shape continuous edge of said first container member enclosing the connector within the first and second receptacles.

2. The enclosure of claim 1, wherein the first container member and the second container member are formed from translucent or transparent UV inhibited plastic material suitable for outdoor use, wherein said plastic material allows visual detection of a connector indicator light.

3. The enclosure of claim 2, wherein said plastic material is polyethylene.

4. The enclosure of claim 1, wherein said tongue and groove coupling is constructed and arranged to operate as a sealing mechanism along a portion of said continuous edge of the first container member and the second container member to create a water-resistant seal.

5. The enclosure of claim 1, wherein said first scallop and said second scallop are formed at an angle to repel rainwater from entering the first container member.

6. The enclosure of claim 1, wherein the tongue shape continuous edge of the second container member and the groove shape continuous edge of the first container member include snap-fit mechanisms to facilitate easy assembly and disassembly of the enclosure.

7. The enclosure of claim 1, wherein said inlet and outlet are constructed and arranged to provide ventilation openings to allow for air circulation and prevent overheating of the connector within the enclosure.

8. The enclosure of claim 1, wherein the first container member and the second container member are configured to accommodate various sizes and types of extension cord connectors, including angled or bulky connectors.

9. The enclosure of claim 1, wherein the first container member is interchangeable with the second container member.

10. The enclosure of claim 1, wherein the first container member can be nested within the second container member.

11. An enclosure for an extension cord connector comprising: a first container member formed from a translucent material and defined as a base wall with first and second vertical side panels and first and second vertical end panels extending upwardly from the periphery of the base wall to a continuous edge forming a first receptacle; said continuous edge having a first scallop centrally disposed along said first vertical end wall forming a portion of an inlet and a second scallop centrally disposed along said second vertical end wall of said continuous edge forming a portion of an outlet, said continuous edge extending from said inlet to said outlet along a first sidewall forming an groove shape, said continuous edge extending from said outlet to said inlet along said second vertical panel forming tongue shape; a second container member forming a second receptacle, said second container member forming a mirror image of said first container member; wherein a connector of a power cord and extension cord is placed in said first receptacle formed by said first container member with said power cord positioned in said inlet and said extension cord placed in said outlet whereby said second container member is secured to said first container member by coupling a tongue shape continuous edge of said second container member to the groove shape continuous edge of said first container member, and said groove shape continuous edge of said second container member to the tongue shape continuous edge of said first container member enclosing the connector within the first and second receptacles, said tongue and groove coupling constructed and arranged to operate as a sealing mechanism a along portion of said continuous edge of the first container member and the second container member to create a water-resistant seal; said tongue shape continuous edge of the second container member and the groove shape continuous edge of the first container member include snap-fit mechanisms.

12. The enclosure of claim 11, wherein said translucent material is UV inhibited plastic material suitable for outdoor use.

13. The enclosure of claim 11, wherein said first scallop and said second scallop are formed at an angle to repel rainwater from entering the first container member.

14. The enclosure of claim 11, wherein said inlet and outlet are constructed and arranged to provide ventilation openings to allow for air circulation and prevent overheating of the connector within the enclosure.

15. The enclosure of claim 11, wherein the first container member and the second container member are configured to accommodate various sizes and types of extension cord connectors, including angled or bulky connectors.

16. The enclosure of claim 11, wherein the first container member is interchangeable with the second container member.

17. The enclosure of claim 11, wherein the first container member can be nested within the second container member.

18. The enclosure of claim 11, wherein said first container member and said second container member are polyethylene.
